(19) United States
(12) Patent Application Publication
(10) Pub. No.: US 2007/0107067 A1
(43) Pub. Date: May 10, 2007

(54) Secure feature activation

(75) Inventor: Thomas D. Fountian, Redwood City, CA (US)

Correspondence Address: PERKINS COIE LLP, P.O. BOX 2168, MENLO PARK, CA, 94026, US

(73) Assignee: Ingrian Networks, Inc., Redwood City, CA (US)

(21) Appl. No.: 10/526,252

(22) PCT Filed: Aug. 25, 2003
(86) PCT No.: PCT/US03/26637

§ 371 Date: Apr. 10, 2006

Related U.S. Application Data
(60) Provisional application No. 60/405,848, filed on Aug. 24, 2002.

(51) Int. Cl. H04N 7/16

(52) U.S. Cl. 726/33

(57) ABSTRACT

A method for a user computer to selectively activate a feature of a software package executing on the user computer includes receiving a feature activation license from a remote server and activating an inactive feature originally present in the software package.

### FIELD OF THE INVENTION

The present invention relates to software licensing techniques and more specifically to a variety of mechanisms for de-coupling software delivery from license delivery and selective activation of software components.

### BACKGROUND OF THE INVENTION

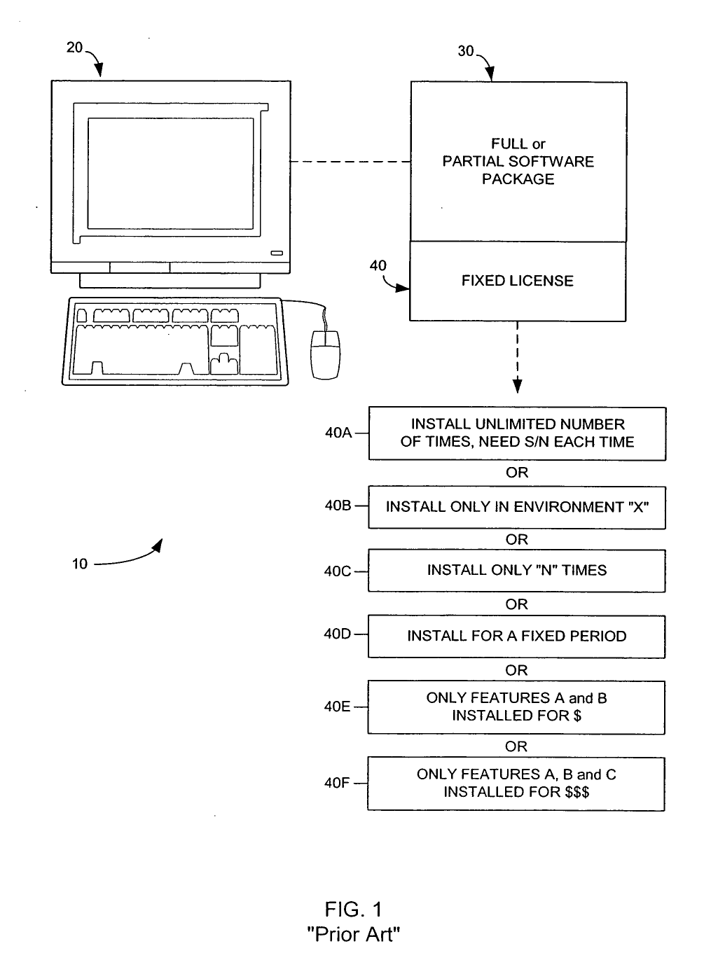

Software vendors have long employed the use of licenses in an effort to minimize unauthorized use of their product. These licenses are for the most part fixed, however, and therefore are limited in their use. FIG. 1 illustrates a typical prior art system 10 for software license implementation. Included is a computer 20 that executes a software package 30 and an associated fixed license 40. Software package 30 can either be a fully installed product or possibly partially installed, i.e. certain features are not installed.

Fixed license 40 can be implemented in numerous embodiments (40A-40F). One example is fixed license 40A wherein a user can install a software product 30 on a computer 20 an unlimited number of times. However, the user is required to input a serial number with each entry. While fixed license 40A is extremely convenient for the consumer, it does not fully protect a software vendor when an unscrupulous individual decides to install the software on more than one machine.

Another example of a software license is fixed license 40B, also associated with software product 30, executing on computer 20. In this instantiation, software product 30 can only be installed in an environment “X”, where “X” can be a particular application or operating environment. This method of licensing also suffers from the drawback that a user is still free to install it on an unlimited number of environments “X”, without the approval of the software vendor.

Fixed licenses 40C and 40D are similar in that they each limit the user in some manner. License 40C only allows a software product 30 to be installed “N” times wherein “N” is some integer. While license 40C is probably convenient for most end users, it is not inconceivable that a user may experience system problems over a period of times and would need to reload software 30 onto computer 20 multiple times. If the user reaches that limit, he obviously would be unhappy when the paid for software is no longer available for use.

License 40D allows a user to install software 30 for a set or fixed period of time. License 40D is useful for allowing a user to “test-drive” a software package 30, it is not inconceivable that a user can adjust a computer system clock (not shown) on computer 20 and thus get around the expiration date of fixed license 40D. Additionally, a user is typically free to re-install software 30 after the expiration date occurs, thus re-starting the clock. While some software vendors have employed mechanisms to prevent this behavior, for example leaving some sort of file on a user's computer 20 that prevents a second installation of software 30 with fixed license 40D, those same mechanisms often dissuade users from trying out the software 30. This is because they do not want unknown files left on their computer 20 after a software product 30 is un-installed.

Another method of licensing is demonstrated via fixed licenses 40E and 40F. Fixed license 40E is typically bundled with software product 30 and for a lower unit price, it typically will not offer all the possible features available. For example, license 40E only includes features A and B, but not feature C. However, license 40F offers all three features (A, B and C), but an associated price for software package 30 will cost more in relation to software 30/license 40E combination. In order to upgrade to a full package, a user typically cannot purchase feature A in a stand-alone upgrade. Most likely, they would have to purchase software package 30/license 40F—thus paying twice for features they already have.

In the case where software is shipped on a machine or device to a consumer or merchant, another issue arises from the use of licenses of the type of 40E and 40F. To build and ship these different products (different sets of features), a unique Stock Keeping Unit (SKU) is used to track each individual product. By necessity, these units must be built, tested, and shipped as separate products. There is often a direct relationship between the cost to produce these products and the number of available variations.

Accordingly, what are needed are methods and techniques for de-coupling the delivery of software from the process of licensing and the enabling of specific software components that allows a software vendor to control when and where their software is used without unduly constraining the end user.

### SUMMARY OF THE INVENTION

The present invention contemplates a variety of improved methods and systems for providing software licensing and selective activation of software components or features. In short, the present invention teaches a variety of sophisticated mechanisms for enabling software functionality in a manner controlled as desired by the software vendor.

A method for a user computer to selectively activate a feature of a software package executing on the user computer, in accordance with an embodiment of the present invention, includes receiving a feature activation license from a remote server and activating an inactive feature originally present in the software package.

A method for selectively activating a feature of a software package executing on a user computer, in accordance with another embodiment of the present invention includes a remote server receiving a request from a user computer for activation of an inactive feature that is originally present in the software package. The remote server processes the request and the remote server sends a feature activation license to the user computer for activating the inactive feature.

A method for selectively activating a feature of a software package executing on a user computer, in accordance with yet another embodiment of the present invention, includes a user requesting activation of an inactive feature originally present in the software package. The user computer transmits a request for a feature activation license to a remote server of a software vendor and the remote server receives the request. The remote server processes the request and sends the feature activation license to the user computer. The user computer then receives the feature activation license and activates the inactive feature.

A system for selectively activating a feature of a software package, in accordance with another embodiment of the present invention includes a system information interface and a device information segment on the system information interface wherein the device information segment shows a product identification and a box identification. Also included is a software list segment on the system information interface wherein the software list segment shows a plurality of installed software packages. Additionally, a feature activation list segment on the system information interface is present wherein the feature activation list shows a status of installed features related to an individual installed software package. Finally, a software upgrade/installation interface on the system information interface wherein the software upgrade/installation interface is utilized for selectively activating an inactive feature, is included as well.

Because the software components of the present invention can be selectively enabled (selective feature activation), the software developer can build and test a single product that can in turn be delivered in a plurality of varieties. This reduces development, testing and operational costs associated with offering an entire suite of products. Selective feature activation requires little interaction with end users and provides a secure mechanism for licensing individual features within the software product. This can be done on a system specific or group specific level.

These and other advantages of the present invention will become apparent to those skilled in the art upon a reading of the following detailed descriptions and a study of the various FIGS.

### BRIEF DESCRIPTION OF THE FIG.S

FIG. 1 illustrates a typical prior art system for software license implementation.

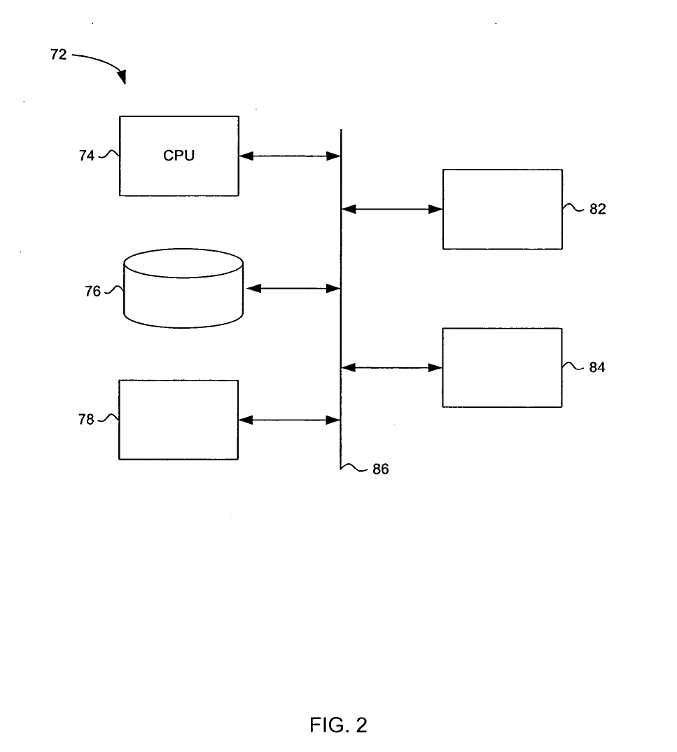

FIG. 2 is a block diagram of a suitable hardware architecture used for supporting selective feature activation, in accordance with the present invention.

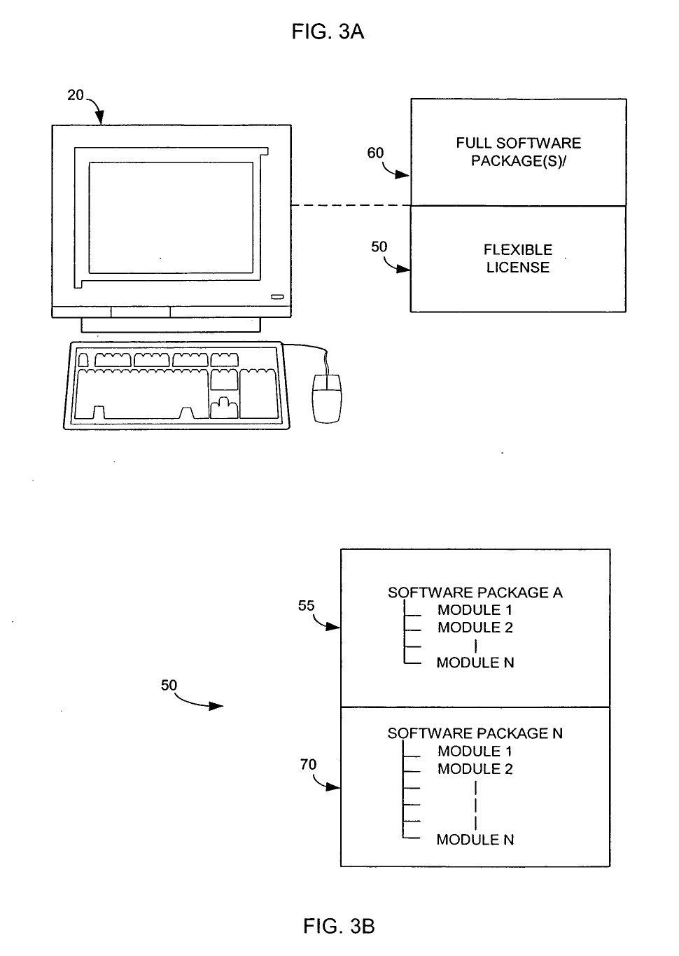

FIG. 3A illustrates the use of a flexible license for controlling distribution of software, in accordance with the present invention.

FIG. 3B is a detailed block diagram of a flexible license, in accordance with the present invention.

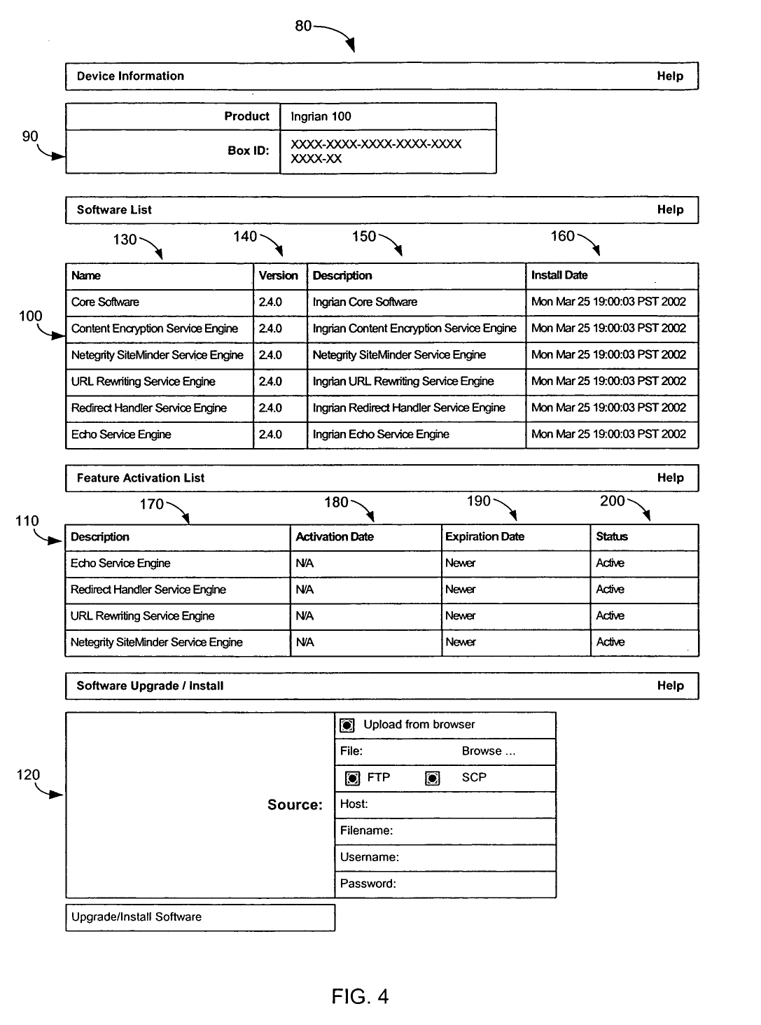

FIG. 4 illustrates a system interface for selectively enabling features of a software package, in accordance with the present invention.

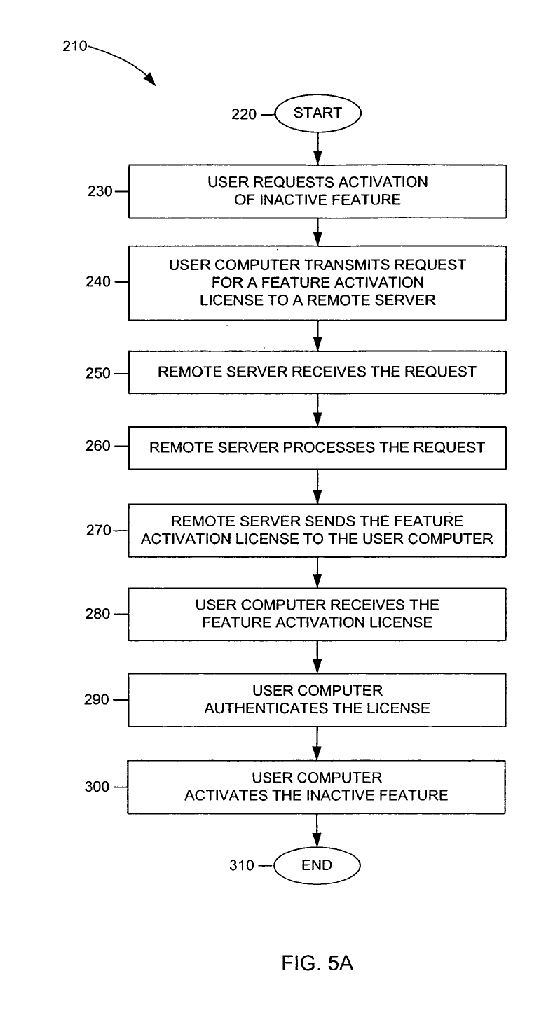

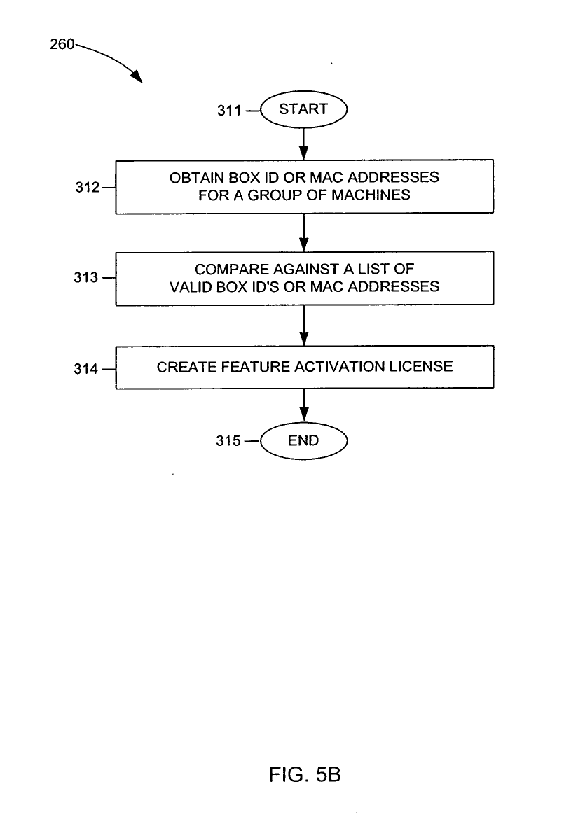

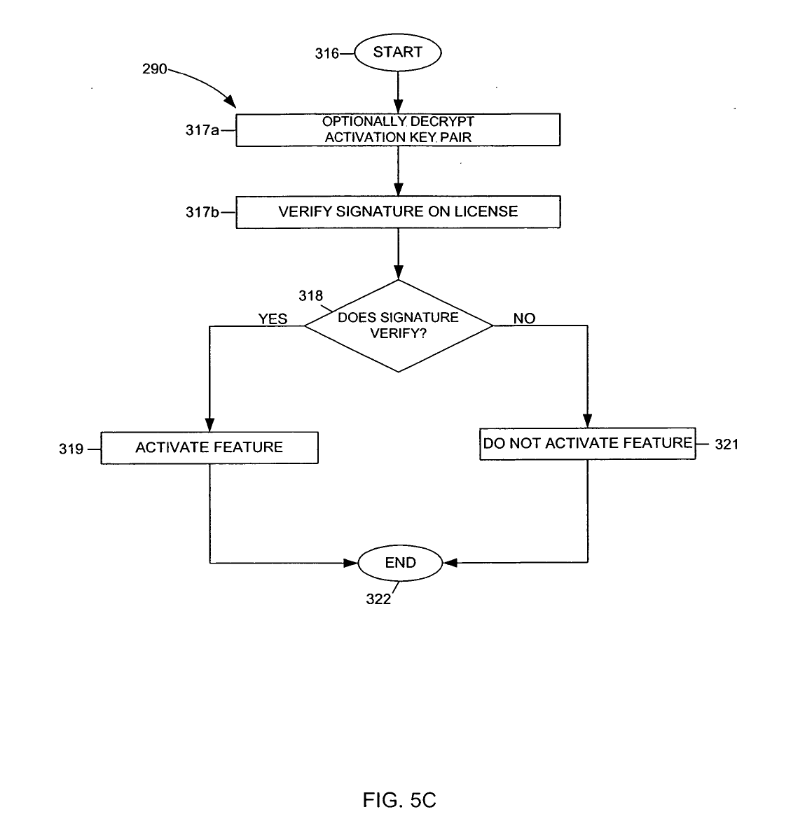

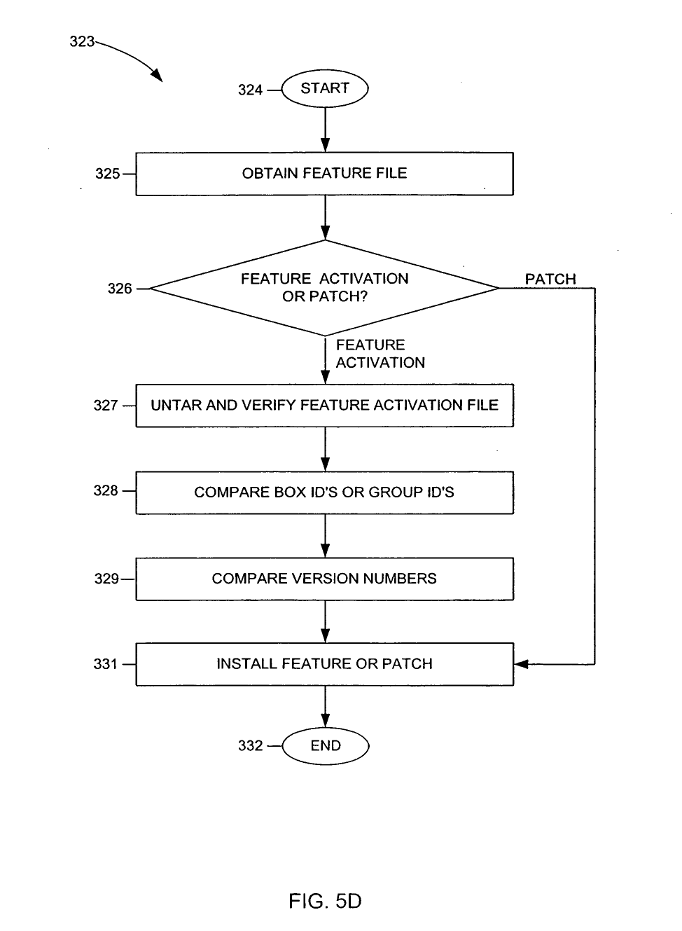

FIG. 5A is a flowchart describing a method of feature activation, in accordance with the present invention.

FIG. 5B is a flowchart describing a method of user verification, in accordance with the present invention.

FIG. 5C is a flowchart describing a method of feature authentication, in accordance with the present invention.

FIG. 5D is a flowchart describing a method of installing a patch or an additional feature, in accordance with an embodiment of the present invention.

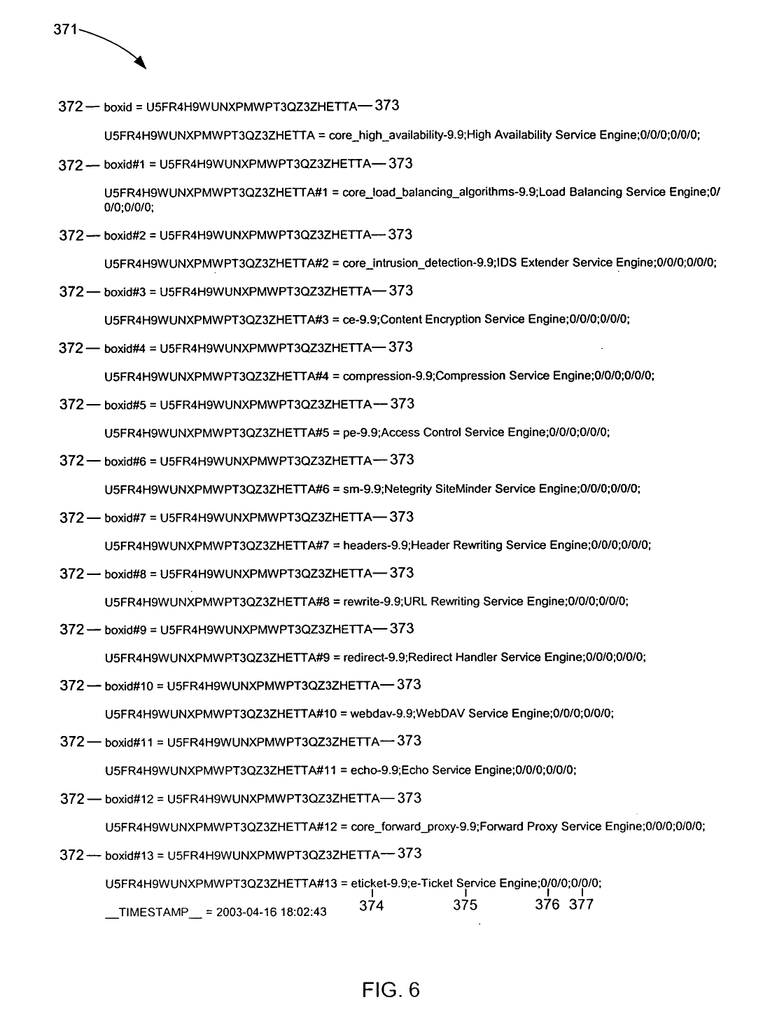

FIG. 6 is an example activation file in accordance with an embodiment of the present invention.

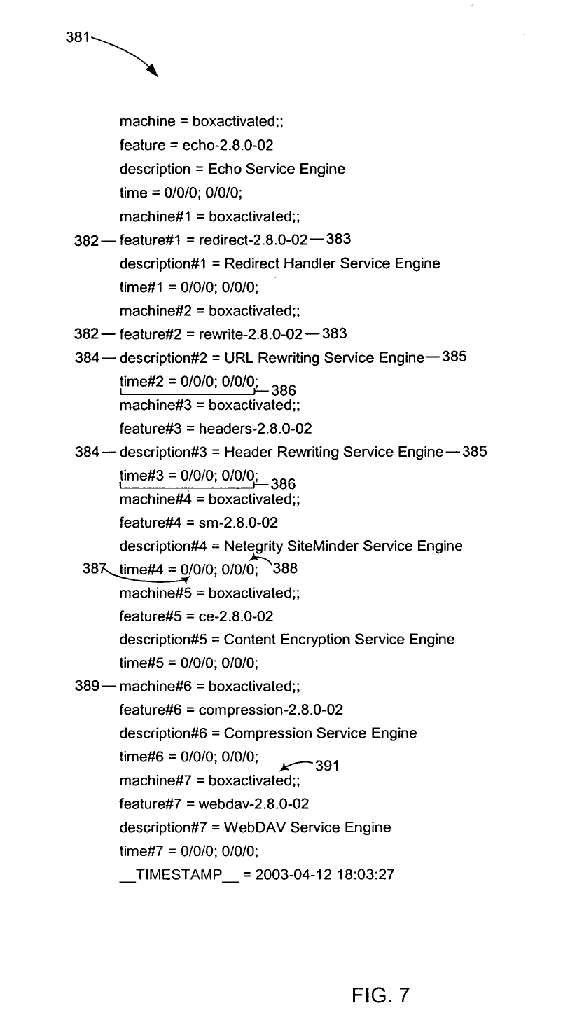

FIG. 7 is an example list of activated features in accordance with an embodiment of the present invention.

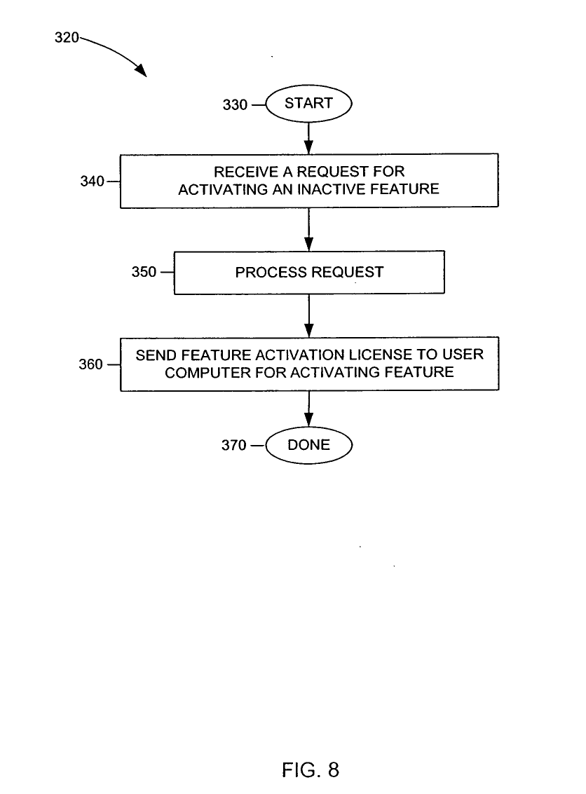

FIG. 8 is a flowchart describing a method of feature activation from a viewpoint of a software vendor, in accordance with the present invention.

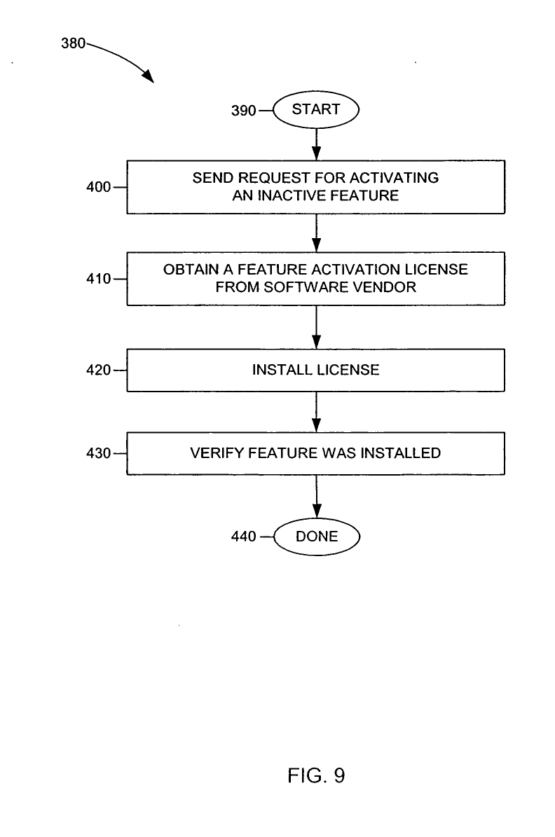

FIG. 9 is a flowchart describing a method of feature activation from a viewpoint of an end user, in accordance with the present invention.

### DETAILED DESCRIPTION OF THE INVENTION

FIG. 1 was described in reference to the prior art. FIG. 2 is a block diagram of a suitable hardware architecture 72 used for supporting selective feature activation, in accordance with the present invention. The hardware architecture 72 includes a central processing unit (CPU) 74, a persistent storage device 76 such as a hard disk, a transient storage device 78 such as random access memory (RAM), a network I/O device 82, and a encryption device 84—all bi-directionally coupled via a databus 86. As will be readily apparent, the hardware architecture 72 is typical of computer systems and thus the present invention is readily implementable on prior art hardware systems. Other additional components such as a graphics card, I/O devices such as a video terminal, keyboard and pointing device, may be part of the hardware architecture 70. One skilled in the art will readily recognize that architecture 72 is but one possible implementation. As such, numerous permutations can be made without departing from the true spirit and scope of the present invention.

FIG. 3A illustrates the use of a flexible license 50 for controlling distribution of software, in accordance with the present invention. Flexible license 50 is bundled with a full software package(s) 60 operating on computer system 20. In the context of the present invention, full software package 55 refers to a software product with multiple features wherein some of the features may possibly not be enabled. Flexible license 50 allows components or features to be selectively enabled after full software package 60 is installed on computer 20. Additionally, a software vendor can configure flexible license 50 whenever a new feature is enabled.

In an embodiment of the present invention, an inactive feature can be activated automatically in response to a particular event. Some of these events can include, for example, an expiration date and an activation of another related inactive feature. One skilled in the art will appreciate that other events can trigger the automatic activation of an inactive feature while not departing from the true scope and spirit of the present invention.

FIG. 3B is a detailed block diagram of a flexible license 50, in accordance with the present invention. Flexible license 50 can also be used to control multiple software products 60 and 70. Each software product 60 and 70 contains multiple modules or features, each of which can be independently enabled or multiply enabled.

FIG. 4 illustrates a system interface for selectively enabling features of a software package 80, in accordance with the present invention. System interface 80 provides a summary of available software and features available in the activation mechanism. Included is a device information segment 90 that conveys basic system information, a software list segment 100, a feature activation list segment 110 and a software upgrade/upgrade interface 120.

Software list segment 100 enumerates the installed software products 130, their versions 140, a short description 150 and an installation date 160. Feature activation list segment 110 lists the available features 170 corresponding to an individual software product 130, an activation date 180, an expiration date 190 and a status 200. Activation date 180 indicates when an individual feature was enabled or “N/A” (not applicable) if that feature was shipped already enabled. Expiration date 190 is used when a feature is to be enabled for a set period of time, for example 30 days. If no expiration date 190 is set, then the feature will stay enabled indefinitely. Status 200 indicates if a particular feature is active or inactive.

Software upgrade/install interface 120 is used for enabling new features. In brief, a user obtains a feature activation license (not shown) from a software vendor and that license allows the user to activate the license. In the context of the present invention, it should be understood that the phrases “feature activation license” and “feature activation file” can be used interchangeably and refers to a data structure for selectively enabling features of a software package or packages. This process of feature activation will be discussed in more detail subsequently. The license can be obtained through various methods such as a through a web browser, FTP (file transfer protocol), SCP (secure copy) or similar methods. Segment 120 can also be used to obtain and install feature enhancement, new features, new software, patches, etc. In one embodiment of the present invention, currency is exchanged between an end user and a software vendor for feature activation, feature enhancements, new features, new software, patches, etc.

FIG. 5A is a flowchart 210 describing a method of feature activation, in accordance with the present invention. Beginning at a start operation 220, a user requests activation of an inactive feature of a software product at operation 230. The request is made through the user's computer and the user's computer transmits a request for a feature activation license to a remote server via operation 240. This request may be communicated through a secure communications channel such as provided by SSL (secure sockets layer) or TLS (transport layer security). The remote server may be any server capable of providing the user a feature activation license. This may be the software vendor, or a corporate server having pre-authorization to provide activation licenses. The remote server receives the request at operation 250 and processes the request at operation 260. The remote server then sends the feature activation license, which can possibly be encrypted, to the user computer at operation 270 and the user computer receives the license at operation 280. The user computer then locally authenticates the license at operation 290, one skilled in the art will recognize that operation 290 can be optional. Authentication is accomplished by verifying the signature and intermediate certificates of the feature activation license The root certificate must match a known public certificate of the software package or device that is receiving the feature activation. At operation 300, the previously inactivated feature is now enabled and the process ends at operation 310.

Multiple features can be simultaneously enabled using the method as described in FIG. 5A. Also, an inactive feature or features may simultaneously activated for a group of machines running a software package. To accomplish this, a user typically will have a system ID and a generic group ID. By submitting the group ID in the request for a feature activation license during operation 230, the feature activation license can be configured to work on that group of systems. The use of ID's will be explained in more detail, subsequently.

FIG. 5B is a flowchart describing a method 260 of user verification, in accordance with the present invention. Method 260 further illustrates operation 260 of Fig. SA. Beginning at a start operation 311; verification that a user is eligible for a feature activation license is accomplished by obtaining a box ID or box ID and MAC (media access control) addresses for a group of machines, from an end user at operation 312. A software vendor then checks the list against a known list of valid box ID's and MAC addresses, at operation 313. Once eligibility is verified, the feature activation license is created, at operation 314. The process ends at operation 315. One skilled in the art will appreciate that in practice, the box ID is typically and generically a mere system identifier. In a preferred embodiment of the present invention, the box ID is derived from the Ethernet MAC addresses.

The feature activation license can be a small file containing the necessary attributes (box ID, feature to activate, etc) and an activation key pair whose use will be described in the next section. The feature activation file may also be encrypted to keep users from viewing the contents of the license, using either a shared symmetric key or an asymmetric private key such as the one used for signing. To support third-party developers, the asymmetric private key used for signing (and possibly encrypting) may be part of a certificate chain with the root certificate being issued by the vendor of the primary software application or hardware device. If the application or device that will receive the activation license does not know the vendor's certificate, the public keys of the certificate chain must also be included in the feature activation license.

FIG. 5C is a flowchart describing a method 290 of feature authentication, in accordance with the present invention. Method 290 further illustrates operation 290 of FIG. 5A. Beginning at operation 316, a public portion of the activation key pair (previously included in the software product) is optionally decrypted at operation 317a. At operation 317b, the signature on the license is verified. This may possibly involve a certificate chain if appropriate. In an alternative embodiment, a user may be prompted to confirm installation of the feature if the license is protected by a chain with unknown intermediate certificate authorities or if the root certificate authority is unknown. Via decision point 318, the feature is activated at operation 319, if the keys match—i.e. the feature activation license was successfully authenticated. Alternatively, if the keys do not match, the feature is not activated via operation 321. The method then ends at operation 322.

FIG. 5D is a flowchart describing a method 323 of installing a patch or an additional feature, in accordance with an embodiment of the present invention. Method 323 can be employed in concert with method 210 of FIG. 5A, since the patch or additional feature is bundled or encapsulated together in a feature file. It should be noted that in this embodiment the phrases “feature file” and “feature activation file” are separate items. . If it is the latter, the feature file then also contains a feature activation file for enabling new features.

Referring back to FIG. 5C, one skilled in the art will appreciate that activate feature operation 319 can include operations 327, 328 and 329 of FIG. 5D.

The method begins at operation 324 and a feature file is obtained from a software vendor at operation 325. The feature file can contain either a patch or new/updated features to install. At an operation 326, a first token of the signature info in the file header (of the feature file) is checked to see if the file is a feature activation or a patch and can be simply denoted as “feature” or “patch”. If it is a patch, it is installed via operation 331. If it is a new feature to be installed, the file is decrypted, verified and the contents of the feature activation file are untarred at operation 327. There will only be one file that is contained within the feature file—the feature activation file and it contains the box ID's and the activation code for the features. It also contains the list of box ID's that this feature activation file can be used for and what features should be activated for each box ID's as well as the services that ought to be restarted after the feature is activated.

The contents of the feature file are verified by ascertaining that there is only one feature activation file contained within the feature file (if it is not of the patch variety) and that it is in the proper format. A box ID of the machine is verified against a known list of box ID's that are included in the feature activation file, at operation 328. If there are no box ID matches, group ID's are then checked. Finally, a check is performed to see if the software has already been installed (in the case of an update to a feature). This is accomplished by checking the version number of the feature in the feature activation file and the version number of the feature already installed on the system, at operation 329. The feature update is installed, if necessary, at operation 331. The method ends at operation 332.

In further regard to the same embodiment of the present invention, the feature activation file will be described in detail. It will be appreciated that this description is not necessarily limited to the patch/feature upgrade embodiment. The design of the feature activation file layout is such that it can accommodate the aggregation of multiple feature files together into a single feature file that can activate different features for each machine. Advantageously, this methodology can keep track of many different patch files for different machines. The format of the feature activation file is designed such that it is easy to parse with a configuration utility. Each feature activation file will also contain a version number corresponding to a version of the activation software that created it.

FIG. 6 is an example activation file 371 in accordance with an embodiment of the present invention. Included in file 371 are plurality of box ID's 372 and associated feature ID's 373. Also included is an abbreviated name 374 of a feature to activate that includes a version number. For example “eticket-9.9”. Following the abbreviated name 374 is the full name 375 (“e-Ticket Service Engine”), a start time 376 and end time 377. In this particular example the feature being activated does not have any time constraints as the dates go from “0/0/0” to “0/0/0”. If the feature is to be activated or a set period of time, for example a 1-month trial period, the dates could take on the form of “4/01/03” to “4/30/03”.

FIG. 7 is an example list 381 of activated features in accordance with an embodiment of the present invention. Included in list 381 is a list of feature ID's 382, associated abbreviated feature names 383 that include a version number, a description ID 384 with associated description name 385 and a time period field 386 that includes a start time 387 and an end time 388. Additionally, the machine field 389 specifies whether a feature is active or inactive. To emphasize, list 381 is a list of features already activated is used by the software program to determine which features are available.

Further embodiments of the present invention will now be described. FIG. 8 is a flowchart describing a method 320 of feature activation from a viewpoint of a software vendor, in accordance with the present invention. Beginning at operation 330, a server of a software vendor receives a request at operation 340, from a user, for activating an inactive feature of a software product. The server processes the request at operation 350 and sends a feature activation license at operation 360. The method then ends at operation 370.

Regarding the generation of box ID's, a box ID is generated based on the MAC addresses of the machine. Each MAC address is 48 bits and the concatenation of two MAC addresses gives a total of 12 bytes. The SHA 1 (secure hash algorithm) hash of the 12 bytes is appended to the concatenated MAC addresses. The hash is 20 bytes which gives a total of 32 bytes. The result is then encrypted with a weak encryption scheme, similar to a “utl_protect” function. The final result is then Base64 encoded.

FIG. 9 is a flowchart describing a method 380 of feature activation from a viewpoint of an end user, in accordance with the present invention. The method begins at operation 390 and a user sends a request for activating an inactive feature through a user computer, via operation 400. At operation 410, the user computer receives a feature activation license from a software vendor. The license is then installed and it is verified that the feature was installed at steps 420 and 430. The method is then completed at step 440.

With further reference to FIG. 8, company “X” web server 470 operates as a feature activation server. A client (460A, 460B, 460C or 460D) sends a secure request for activation of an inactive feature. The secure request is sent through the network 480 to SRP 490, where it is cached and processed. SRP 490 then forwards the processed request to the company “X” web server 470. Web server 470 processes the request and sends out a feature activation license to the client (460A, 460B, 460C or 460D) via the SRP 490 and network 480. Upon receipt of the feature activation license, the client (460A, 460B, 460C or 460D) typically will authenticate the license and then enable the previously inactive features. This process is further illustrated via FIG. 9.

Because the software components of the present invention can be selectively enabled (selective feature activation), the software developer can build and test a single product that can in turn be delivered in a plurality of varieties. This reduces development, testing and operational costs associated with offering an entire suite of products. Selective feature activation requires little interaction with end users and provides a secure mechanism for licensing individual features within the software product. This can be done on a system specific or group specific level.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A method for a user computer to selectively activate a feature of a software package executing on the user computer comprising:
receiving a feature activation license from a remote server; and
activating an inactive feature originally present in the software package.

2. The method as recited in claim 1 further comprising sending a request for activation of the inactive feature from a user computer to the remote server before the feature activation license is received by the remote server.

3. The method as recited in claim 2 wherein the inactive feature is not present in the software package and the inactive feature is bundled with the feature activation license.

4. The method as recited in claim 1 wherein the inactive feature is activated automatically in response to a particular event.

5. The method as recited in claim 4 wherein the particular event is an expiration date.

6. The method as recited in claim 4 wherein the particular event is activation of another related inactive feature.

7. The method as recited in claim 1 wherein the feature activation license is authenticated before the inactive feature is activated.

8. The method as recited in claim 1 wherein currency is exchanged from a user of the software package to the software vendor in exchange for the feature activation license.

9. The method as recited in claim 1 wherein the inactive feature is activated for a set period of time.

10. The method as recited in claim 1 wherein a plurality of inactive features are activated concurrently.

11. The method as recited in claim 1 wherein the feature activation license is encrypted.

12. The method as recited in claim 11 wherein the feature activation license is encrypted via a shared symmetric key.

13. The method as recited in claim 11 wherein the feature activation license is encrypted via an asymmetric private key.

14. The method as recited in claim 1 wherein the feature activation license is verified via a plurality of digital certificates.

15. The method as recited in claim 1 further comprising adding a new feature to the software package wherein the new feature is encapsulated with the feature activation license.

16. The method as recited in claim 15 wherein a user of the software package is given an option of obtaining the new feature after requesting the feature activation license.

17. The method as recited in claim further 1 comprising adding a patch to the software package wherein the patch is encapsulated with the feature activation license.

18. The method as recited in claim 17 wherein a user of the software package is given an option of obtaining the patch after requesting the feature activation license.

19. A method for selectively activating a feature of a software package executing on a user computer comprising:
a remote server receives a request from a user computer for activation of an inactive feature that is originally present in the software package;
the remote server processes the request; and
the remote server sends a feature activation license to the user computer for activating the inactive feature.

20. The method as recited in claim 19 wherein the inactive feature is not originally present in the software package and is bundled with the feature activation license.

21. The method as recited in claim 19 wherein the feature activation license is authenticated before the inactive feature is activated.

22. The method as recited in claim 19 wherein currency is exchanged from the user to the software vendor in exchange for the feature activation license.

23. The method as recited in claim 19 wherein the inactive feature is activated on a single computer.

24. The method as recited in claim 19 wherein the inactive feature is activated for a set period of time.

25. The method as recited in claim 19 wherein a plurality of inactive features are activated concurrently.

26. The method as recited in claim 19 wherein the inactive feature is activated for a specific device.

27. The method as recited in claim 19 wherein a feature is activated on a plurality of devices.

28. The method as recited in claim 27 wherein the feature is activated for the plurality of devices via a group identifier.

29. The method as recited in claim 19 wherein the feature activation license is encrypted.

30. The method as recited in claim 29 wherein the feature activation license is encrypted via a shared symmetric key.

31. The method as recited in claim 29 wherein the feature activation license is encrypted via an asymmetric private key.

32. The method as recited in claim 19 wherein the feature activation license is verified via a plurality of digital certificates.

33. The method as recited in claim 19 further comprising adding a new feature to the software package wherein the new feature is encapsulated with the feature activation license.

34. The method as recited in claim 33 wherein the user is given an option of obtaining the new feature after requesting the feature activation license.

35. The method as recited in claim further 19 comprising adding a patch to the software package wherein the patch is encapsulated with the feature activation license.

36. The method as recited in claim 35 wherein the user is given an option of obtaining the patch after requesting the feature activation license.

37. The method as recited in claim 19 wherein the feature activation license is obtained electronically.

38. The method as recited in claim 37 wherein the feature activation license is obtained through email.

39. The method as recited in claim 37 wherein the feature activation license is obtained through a through an Internet web interface.

40. The method as recited in claim 37 wherein the feature activation license is obtained via FTP.

41. The method as recited in claim 37 wherein the feature activation license is obtained via SCP.

42. A method for selectively activating a feature of a software package executing on a user computer comprising:
a user requesting activation of an inactive feature originally present in the software package;
the user computer transmits a request for a feature activation license to a remote server of a software vendor;
the remote server receives the request;
the remote server processes the request;
the remote server sends the feature activation license to the user computer;
the user computer receives the feature activation license; and
the user computer activates the inactive feature.

43. The method as recited in claim 42 wherein the feature activation license is authenticated before the inactive feature is activated.

44. The method as recited in claim 42 wherein currency is exchanged from a user of the software package to the software vendor in exchange for the feature activation license.

45. The method as recited in claim 42 wherein the feature activation license is obtained though a human interaction.

46. A system for selectively activating a feature of a software package comprising:
a system information interface;
a device information segment on the system information interface wherein the device information segment shows a product identification and a box identification;
a software list segment on the system information interface wherein the software list segment shows a plurality of installed software packages;
a feature activation list segment on the system information interface wherein the feature activation list shows a status of installed features related to an individual installed software package; and
a software upgrade/installation interface on the system information interface wherein the software upgrade/installation interface is utilized for selectively activating an inactive feature.

47. The system as recited in claim 46 wherein the software list segment is further comprised of a name, a version, a description and an install date each of which is related to the individual software package.

48. The system as recited in claim 46 wherein the feature activation list segment is further comprised of a description, an activation date, an expiration date and a status each of which is related to an individual installed feature of the individual installed software package.

49. The system as recited in claim 46 wherein a feature activation license is obtained via the software upgrade/installation interface.

50. The system as recited in claim 49 wherein the feature activation license is obtained though an Internet web interface.

51. The system as recited in claim 49 wherein the feature activation license is obtained via FTP.

52. The system as recited in claim 49 wherein the feature activation license is obtained via SCP.

53. A data structure for use in selectively activating a feature of a software package executing on a user computer comprising:
a box identification corresponding to the user computer; and
a box feature identification that has a list of features to be activated.

54. A data structure for use in selectively activating a feature of a software package executing on a group of user computers comprising:
a group identification corresponding to the user computer; and
a group feature identification that has a list of features to be activated.

55. A software package which has inactive features that can only be activated through obtaining a feature activation license.

56. A method for determining a computer box identifier comprising:
obtaining a MAC identifier;
obtaining a system information component relating to the computer box; and
combining the MAC identifier and the system information component into the computer box identifier.
